(19) United States
(12) Patent Application Publication
(10) Pub. No.: US 2025/0040752 A1
(43) Pub. Date: Feb. 6, 2025

(54) PORTABLE INTERNET OF THINGS (IOT) BASED FOOD PROCESSING DEVICE FOR AUTOMATED COOKING AND PREPPING OF CONTENTS IN CONTAINERS

(71) Applicant: Prashant Singh Sengar, West Hills, CA (US)

(72) Inventor: Prashant Singh Sengar, West Hills, CA (US)

(21) Appl. No.: 18/792,867

(22) Filed: Aug. 2, 2024

Related U.S. Application Data
(60) Provisional application No. 63/530,830, filed on Aug. 4, 2023.

(51) Int. Cl. A47J 36/32; A47J 43/044; A47J 43/07; A47J 44/00; B01F 27/091; B01F 27/112; B01F 27/90; B01F 33/501; B01F 35/21; B01F 35/22; B01F 35/221; B05B 7/24; F24C 15/20; G06V 20/50; H05B 6/06

(52) U.S. Cl. CPC A47J 36/321; A47J 43/044; A47J 43/0711; A47J 44/00; B01F 27/091; B01F 27/112; B01F 27/90; B01F 33/5011; B01F 35/2117; B01F 35/2205; B01F 35/221422; B05B 7/2489; F24C 15/2021; G06V 20/50; H05B 6/062; A47J 2043/04418; H05B 2213/07

(57) ABSTRACT

A portable IoT based food processing device for automated cooking and prepping of contents, is disclosed. The portable IoT based food processing device includes a stirring paddler device connected to a stirring shaft through a first coupler for adapting stirring paddler device to stir contents. The automatic stirring apparatus is connected to clamping arms to adapt for various container sizes using slider motion. The automatic stirring apparatus includes first microcontroller to: receive inputs from first user interfaces and touch buttons, of the automatic stirring apparatus, second user interfaces and touch screens, of IoT based hand blender device and applications in user devices; capture images from camera devices, receive sensor data from sensors; and match sensor data and type of contents, with computed load of contents to compute cooking time, control speed and direction of rotation of first variable speed DC motor for stirring contents using stirring paddler device.

### CROSS REFERENCE TO RELATED APPLICATION(S)

This application claims the priority to incorporates by reference the entire disclosure of U.S. provisional patent application No. 63/530,830 filed on Aug. 4, 2023 titled “IoT (Internet of Things) enabled cordless hand blender system for cooking, automated pot stirring, food processing, and nutrition estimation.”.

### FIELD OF INVENTION

Embodiments of the present disclosure relate to an Internet of Things (IoT) based multipurpose portable handheld kitchen appliances, and more particularly relate to portable Internet of Things (IoT) based food processing devices for automated cooking and prepping of one or more contents in one or more containers.

### BACKGROUND

Food preparation involves a variety of steps and processes, including at least one of: stirring pots, monitoring temperatures, mixing, flipping, blending, chopping, whisking, frothing, kneading, and the like. Additionally, food needs to be weighed on kitchen scales to estimate nutritional content. Stirring pots, in particular, is a time-consuming and repetitive task that demands continuous attention. Neglecting the process of stirring the pots may lead to burning, scorching, and inconsistent results, to the contents. Performing the above said tasks typically require multiple kitchen appliances.

The pot stirring devices currently on the market have several limitations. The current pot stirring devices may not evenly mix or flip larger solids in substantial quantities. The current pot stirring devices are unable to retain heat for quicker cooking, and lack wireless monitoring and control capabilities (i.e., through mobile devices). Additionally, the current pot stirring devices may not reduce or eliminate cooking odors, detect food types to automate the cooking process, or automatically adjust stirring speed and direction. In addition, cordless hand blenders offer limited functionality, forcing users to rely on multiple other appliances, which can clutter kitchen space and increase costs.

The above said pot stirring devices may have low power, limited speed, and only offer single-direction stirring, restricting their usefulness when cooking various recipes. The pot stirring devices may also lack features including at least one of: environment sensing, multitasking, learning capabilities, and the option for user reprogramming. As a result, the pot stirring devices may fail to offer significant assistance to users during the cooking process.

Hence, there is a need for an improved Internet of Things (IoT) based food processing device for automated cooking and prepping of one or more contents in one or more containers, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a portable Internet of Things (IoT) based food processing device for automated cooking and prepping of one or more contents in one or more containers, is disclosed. The portable Internet of Things (IoT) based food processing device includes a stirring paddler device connected to a stirring shaft through a first coupler for adapting the stirring paddler device to stir the one or more contents in the one or more containers.

An automatic stirring apparatus configured to connect to at least two clamping arms to adapt for a slider motion of the automatic stirring apparatus. The automatic stirring apparatus is configured to be mounted on a top of the one or more containers by utilizing the at least two clamping arms with at least two clamps and by placing the automatic stirring apparatus over a stirrer assembly. The at least two clamping arms comprise the at least two clamps configured to hold the one or more containers. The at least two clamping arms with the at least two clamps are configured to be adjusted based on size of the one or more containers.

The automatic stirring apparatus includes a first microcontroller in one or more controller printed circuit boards (PCB) configured to: (a) receive one or more inputs from at least one of: one or more first user interfaces and one or more touch buttons, of the automatic stirring apparatus, one or more second user interfaces and one or more touch screens, of an internet of things (IoT) based hand blender device, and one or more applications configured in one or more user devices; (b) receive at least one of: one or more images from one or more first camera devices and one or more sensor data from one or more sensors configured in the automatic stirring apparatus, wherein the one or more sensor data received from the one or more sensors comprise at least one of: one or more temperature data and one or more smoke data, associated with the one or more containers during cooking and prepping of the one or more contents and wherein the one or more images received from the one or more first camera devices are processed with image recognition technique to determine a type of the one or more contents present in the one or more containers; (c) transmit one or more signals to run at least one first variable speed 12-volt direct current (DC) motor to compute a load of the one or more contents in the one or more containers; and (d) match the one or more sensor data and the determined type of the one or more contents, with the computed load of the one or more contents to control speed and direction of rotation of the at least one first variable speed 12-volt direct current (DC) motor in at least one of: clockwise and counter clockwise direction, for stirring the one or more contents in the one or more containers using the stirring paddler device.

The automatic stirring apparatus further comprises a range hood device (i.e., a miniature kitchen hood) freely attached to the automatic stirring apparatus using one or more pogo pins, wherein the range hood device comprises a circulation fan mechanically connected to at least one second variable speed 12-volt direct current (DC) motor. The range hood device is controlled by the first microcontroller for at least one of: circulating heat, removing moisture, and filtering smoke, from the one or more containers during cooking process using the circulation fan. The at least one second variable speed 12-volt direct current (DC) motor is configured to control speed of the circulation fan to vent the smoke and to provide one or more alerts to the one or more users, when a level of at least one of: temperature and the smoke, of the one or more containers exceeds one or more pre-determined threshold values.

In an embodiment, the one or more first camera devices configured to: capture the one or more images associated with the one or more contents in the one or more containers using the image recognition technique; and transmit the one or more images associated with the one or more contents, to the first microcontroller. The first microcontroller is configured to: automatically set a cooking timer for a corresponding content in the one or more containers, based on the one or more images received from the one or more first camera devices; and automatically mange the control speed and direction of the rotation of the at least one first variable speed 12-volt direct current (DC) motor for stirring the one or more contents in the one or more containers using the stirring paddler device, based on the one or more images captured by the one or more first camera devices and the one or more sensor data received from the one or more sensors.

In another embodiment, the range hood device further comprises an atomiser transducer device configured to spray one or more type of liquids in the one or more containers to dissipate heat when at least one of: burning, scorching, and sudden rise in surface temperature of the one or more containers. The atomiser transducer device is configured for spraying liquid seasonings, onto the contents in the one or more containers at a pre-defined time interval.

In yet another embodiment, the stirring paddler device comprises at least one of: at least one primary stirring paddle and at least one scrapper stirring paddle, for stirring the one or more contents in the one or more containers, and wherein at least one of: the at least one primary stirring paddle and the at least one scrapper stirring paddle, is mechanically connected to the first coupler. The at least one primary stirring paddle and the at least one scrapper stirring paddle are configured to be adjusted to adapt the size of the one or more containers. The at least one primary stirring paddle and the at least one scrapper stirring paddle are configured to adapt for at least one of: clockwise rotation and counterclockwise rotation, to evenly mix the one or more contents in the one or more containers.

In yet another embodiment, the first microcontroller is configured to: determine at least one of: burning, scorching and sudden rise in the surface temperature, in the one or more containers when at least one of: temperature and smoke, in the one or more containers exceeds the pre-determined threshold value; and send an alert to the one or more user devices associated with one or more users upon at least one of: burning, scorching, and sudden rise in the surface temperature, in the one or more containers.

In yet another embodiment, the portable IoT based food processing device further comprises an internet of things (IoT) based hand blender device configured to process the one or more contents in the one or more containers. The internet of things (IoT) based hand blender device comprises one or more controller printed circuit boards (PCB) comprising a second microcontroller. The second microcontroller is configured to: receive the one or more inputs from at least one of: the one or more second user interfaces and one or more snap action switches, of the internet of things (IoT) based hand blender device, and the one or more applications configured in the one or more user devices; and control at least one third variable speed 12-volt direct current (DC) motor to process the one or more contents based on the one or more inputs received from at least one of: the one or more second user interfaces and the one or more snap action switches, of the internet of things (IoT) based hand blender device, and the one or more applications configured in the one or more user devices.

In yet another embodiment, the internet of things (IoT) based hand blender device further comprises a kitchen scales attachment electrically connected to the internet of things (IoT) based hand blender device for weighing the one or more contents placed on a weighing tray using one or more weighing sensors attached with the weighing tray. The kitchen scales attachment is freely moved, using an electrical wire, to accommodate one or more sizes of the one or more containers for weighing the one or more containers. The one or more weighing sensors are configured to provide one or more electrical data associated with the weightage of the one or more contents, to the internet of things (IoT) based hand blender device to compute one or more nutritional values in the one or more contents. The kitchen scales attachment in connection with the internet of things (IoT) based hand blender device, is configured to at least one of: create one or more recipes and follow a guided cooking.

In yet another embodiment, the second microcontroller is configured to: obtain the one or more electrical data associated with the weightage of the one or more contents; compare the one or more electrical data associated with the weightage of the one or more contents, with one or more pre-determined data associated with the one or more nutritional values in the one or more contents; and compute the nutrition in the one or more contents based on the comparison of the one or more electrical data associated with the weightage of the one or more contents, with the one or more pre-determined data associated with the one or more nutritional values in the one or more contents.

In yet another embodiment, the internet of things (IoT) based hand blender device further comprises one or more second camera devices configured to capture the one or more contents to determine one or more types of the one or more contents using the image recognition technique. The second microcontroller utilizing the one or more second camera devices in connection with the kitchen scales attachment, is configured to detect one or more content type using the image recognition technique and to estimate the one or more nutritional values based on the one or more electrical data associated with the weightage.

In yet another embodiment, the at least one third variable speed 12-volt direct current (DC) motor is mechanically connected to one or more second reduction gears to drive a food processor attachment with a food processor container. The food processor attachment is fitted with the one or more weighing sensors to weigh the one or more contents in the food processor container and to send the one or more electrical data associated with the weightage to the second microcontroller for at least one of: nutrition estimation and the recipe creation.

In yet another embodiment, the at least one third variable speed 12-volt direct current (DC) motor is mechanically connected with a shaft fitted with a second coupler, which protrudes out of a housing of the internet of things (IoT) based hand blender device. The shaft is mechanically attached to one or more third reduction gears to drive a beater attachment.

In yet another embodiment, the internet of things (IoT) based hand blender device further comprises one or more pogo pins mechanically connected to the kitchen scales attachment through one or more pogo pin connectors, to weigh the one or more contents and to communicate the weightage of the one or more contents to the one or more second user interfaces through the second microcontroller.

In yet another embodiment, the internet of things (IoT) based hand blender device further comprises one or more locking buttons that are configured to connect to at least one of: one or more content processing tools and the kitchen scales attachment. The one or more locking buttons connected to the one or more content processing tools are configured to control the one or more content processing tools when the one or more content processing tools are required to process.

In yet another embodiment, cooking and prepping of the one or more contents in the one or more containers comprise at least one of: mixing, blending, chopping, grinding, crushing, whisking, frothing, kneading, of the one or more contents in the one or more containers.

In yet another embodiment, the portable Internet of Things (IoT) based food processing device further comprises a companion apparatus connected with the automatic stirring apparatus for preparing the one or more contents in the one or more containers. The companion apparatus comprises: (a) an induction cooktop device with a thermometer for measuring surface temperature; (b) one or more legs connected with one or more load sensors for weighing the one or more contents in the one or more containers; (c) a mounting arm configured for holding the automatic stirring apparatus; (d) a hinge for combining the mounting arm and the induction cooktop device; and (e) a lid arranged on top of the one or more containers. The lid is mechanically attached to the mounting arm. The automatic stirring apparatus connected to the induction cooktop device, is configured to collect at least one of: the one or more inputs from the one or more users, the one or more sensor data, the one or more images to compute cooking time, cooking temperature, stirring speed, and the direction of the rotation of the at least one first variable speed 12-volt direct current (DC) motor.

In one aspect, an Internet of Things (IoT) based food processing method for automated cooking and prepping of one or more contents in one or more containers using a portable Internet of Things (IoT) based food processing device, is disclosed. The Internet of Things (IoT) based food processing method comprises connecting a stirring paddler device to a stirring shaft through a first coupler for adapting the stirring paddler device to stir the one or more contents in the one or more containers.

The Internet of Things (IoT) based food processing method further comprises connecting an automatic stirring apparatus to at least two clamping arms to adapt for a slider motion of the automatic stirring apparatus. The automatic stirring apparatus is configured to be mounted on a top of the one or more containers by utilizing the at least two clamping arms with at least two clamps and by placing the automatic stirring apparatus over a stirrer assembly. The at least two clamping arms comprise the at least two clamps configured to hold the one or more containers. The at least two clamping arms with the at least two clamps are configured to be adjusted based on size of the one or more containers.

The Internet of Things (IoT) based food processing method further comprises receiving, by a first microcontroller, one or more inputs from at least one of: one or more first user interfaces and one or more touch buttons, of the automatic stirring apparatus, one or more second user interfaces and one or more touch screens, of an internet of things (IoT) based hand blender device, and one or more applications configured in one or more user devices.

The Internet of Things (IoT) based food processing method further comprises receiving, by the first microcontroller, at least one of: one or more images from one or more first camera devices and one or more sensor data from one or more sensors configured in the automatic stirring apparatus. The one or more sensor data received from the one or more sensors comprise at least one of: one or more temperature data and one or more smoke data, associated with the one or more containers during cooking and prepping of the one or more contents. The one or more images received from the one or more first camera devices are processed with image recognition technique to determine a type of the one or more contents present in the one or more containers.

The Internet of Things (IoT) based food processing method further comprises transmitting, by the first microcontroller, one or more signals to run at least one first variable speed 12-volt direct current (DC) motor to compute a load of the one or more contents in the one or more containers.

The Internet of Things (IoT) based food processing method further comprises matching, by the first microcontroller, the one or more sensor data and the determined type of the one or more contents, with the computed load of the one or more contents to control speed and direction of rotation of the at least one first variable speed 12-volt direct current (DC) motor in at least one of: clockwise and counter clockwise direction, for stirring the one or more contents in the one or more containers using the stirring paddler device.

The Internet of Things (IoT) based food processing method further comprises connecting a range hood device to the automatic stirring apparatus using one or more pogo pins, wherein the range hood device comprises a circulation fan mechanically connected to at least one second variable speed 12-volt direct current (DC) motor. The range hood device is controlled by the first microcontroller for at least one of: circulating heat, removing moisture, and filtering smoke, from the one or more containers during cooking process using the circulation fan. The at least one second variable speed 12-volt direct current (DC) motor is configured to control speed of the circulation fan to vent the smoke and to provide one or more alerts to the one or more users, when a level of at least one of: temperature and the smoke, of the one or more containers exceeds one or more pre-determined threshold values.

In another aspect, a non-transitory computer-readable storage medium having instructions stored therein that, when executed by a hardware processor, causes the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a schematic representation illustrating portable Internet of Things (IoT) based food processing devices for automated cooking and prepping of one or more contents in one or more containers, in accordance with an embodiment of the present disclosure;

FIG. 2 is a schematic representation illustrating an automatic stirring apparatus, such as those shown in FIG. 1, in accordance with another embodiment of the present disclosure;

FIG. 3 is a schematic representation illustrating a detailed view of the automatic stirring apparatus, such as those shown in FIG. 2, in accordance with an embodiment of the present disclosure;

FIG. 4 is a schematic representation illustrating tubular type probe holder and one or more pogo pins for a range hood device arranged in the automatic stirring apparatus, in accordance with an embodiment of the present disclosure;

FIG. 5 is a schematic representation illustrating one or more clamping arms with at least two clamps, in accordance with an embodiment of the present disclosure;

FIG. 6 is a schematic representation of the range hood device (i.e., a miniature kitchen hood) which freely attaches to the back side of the automatic stirring apparatus, in accordance with an embodiment of the present disclosure;

FIG. 7 is a schematic representation illustrating a stirring paddler device with scrapper stirring paddle for stirring the one or more contents in the one or more containers, in accordance with an embodiment of the present disclosure;

FIG. 8 is a top view of the stirring paddler device with the scrapper stirring paddle for stirring the one or more contents in the one or more containers, in accordance with an embodiment of the present disclosure;

FIGS. 9A-9B are schematic representations depicting front and back view of an IoT based hand blender device (e.g., an IoT based cordless hand blender device) for cooking and prepping the one or more contents in the one or more containers, in accordance with an embodiment of the present disclosure;

FIGS. 10A-10B are schematic representations depicting the IoT based hand blender device with a kitchen scales attachment for weighing the one or more contents, in accordance with an embodiment of the present disclosure;

FIG. 11 is a schematic representation depicting the IoT based hand blender device with the kitchen scales attachment through an electrical wire, in accordance with an embodiment of the present disclosure;

FIG. 12 is a schematic representation depicting the IoT based hand blender device coupled with one or more blades through a shaft and a coupler, in accordance with an embodiment of the present disclosure;

FIG. 13 is a schematic representation depicting the IoT based hand blender device coupled with a mixer or beater attachment using one or more third reduction gears, in accordance with an embodiment of the present disclosure;

FIGS. 14A-14B are schematic representations depicting the IoT based hand blender device coupled with the food processor attachment to drive the food processor container using one or more second reduction gears, in accordance with an embodiment of the present disclosure;

FIG. 15 is an exploded view depicting a stirring shaft assembly including a stirring shaft attached with a temperature probe, in accordance with an embodiment of the present disclosure;

FIG. 16 is a schematic representation depicting a companion apparatus connected with the automatic stirring apparatus for preparing the one or more contents in the one or more containers, in accordance with an embodiment of the present disclosure;

FIG. 17 is a schematic representation depicting a grinder attachment for the automatic stirring apparatus to process coffee beans or spices, in accordance with an embodiment of the present disclosure;

FIG. 18 is a flow chart illustrating an Internet of Things (IoT) based food processing method for automated cooking and prepping of the one or more contents in the one or more containers using the automatic stirring apparatus, in accordance with an embodiment of the present disclosure; and

FIG. 19 is a flow chart illustrating the Internet of Things (IoT) based food processing method for automated cooking and prepping of the one or more contents in the one or more containers using the internet of things (IoT) based hand blender device, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed, permanently configured (hardwired) or temporarily configured (programmed) to operate in a certain manner and/or to perform certain operations described herein.

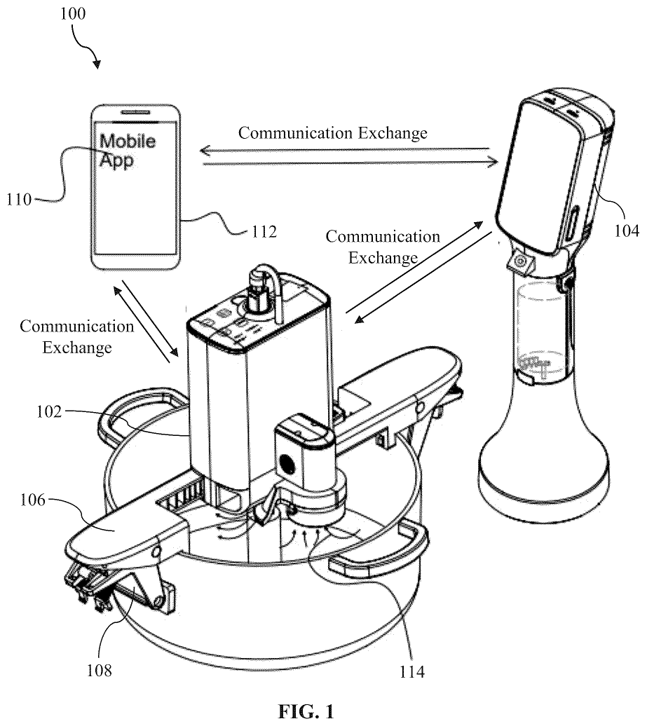

Referring now to the drawings, and more particularly to FIG. 1 through FIG. 19, where similar reference characters denote corresponding features consistently throughout the figures, there are shown preferred embodiments and these embodiments are described in the context of the following exemplary system and/or method.

FIG. 1 is a schematic representation 100 illustrating portable Internet of Things (IoT) based food processing devices for automated cooking and prepping of one or more contents in one or more containers, in accordance with an embodiment of the present disclosure. According to FIG. 1, the portable Internet of Things (IoT) based food processing devices include an automatic stirring apparatus 102 and an IoT based hand blender device 104 (e.g., an IoT based cordless hand blender device 104). In an embodiment, the automatic stirring apparatus 102 and the IoT based hand blender device 104 are independent apparatuses of the Internet of Things (IoT) based food processing device.

The automatic stirring apparatus 102 and the IoT based hand blender device 104 are operated based on one or more inputs received from one or more users through one or more user devices 112. In an embodiment, the one or more users may select one or more cooking recipes that are pre-stored in an application 110 configured in the one or more user devices 112. In an embodiment, one or more features and the one or more cooking recipes are wirelessly transferred to the food processing devices through the application 110 using a communication network (e.g., Wireless Fidelity (Wi-Fi) network).

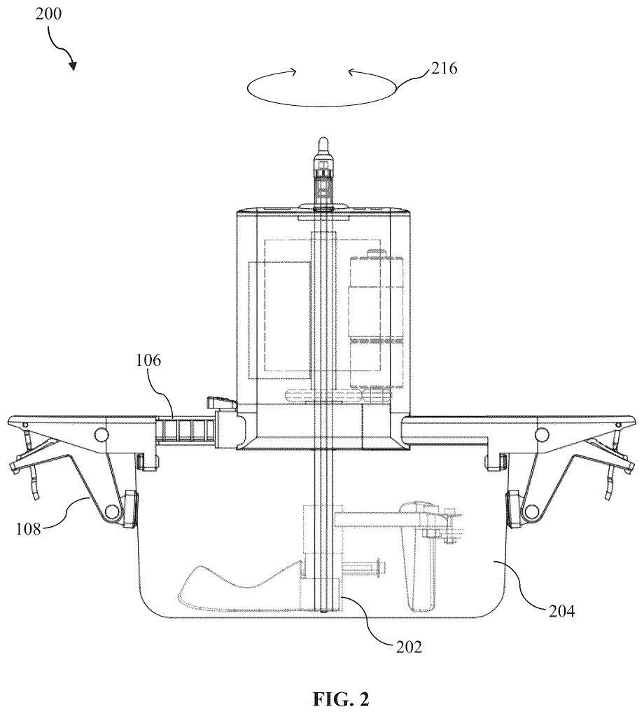

FIG. 2 is a schematic representation 200 illustrating the automatic stirring apparatus 102, such as those shown in FIG. 1, in accordance with another embodiment of the present disclosure. The automatic stirring apparatus 102 is configured to receive one or more inputs from the one or more users through one or more input devices. In an embodiment, the one or more inputs may include one or more processes/operations to be performed by the automatic stirring apparatus 102. In another embodiment, the one or more inputs may include at least one of: the one or more features and the one or more recipe information provided by the one or more users through the one or more user interfaces either from the display on the automatic stirring apparatus 102 or with the one or more user devices 112.

The automatic stirring apparatus 102 is configured to be mounted on a top of the one or more containers 204. The automatic stirring apparatus 102 is configured to mechanically connect with at least two clamping arms 106 to adapt for a slider motion of the automatic stirring apparatus 102. In an embodiment, the at least two clamping arms 106 may include at least two clamps 108 configured to hold the one or more containers 204. In an embodiment, the at least two clamping arms 106 with the at least two clamps 108 are configured to be adjusted based on size of the one or more containers 204.

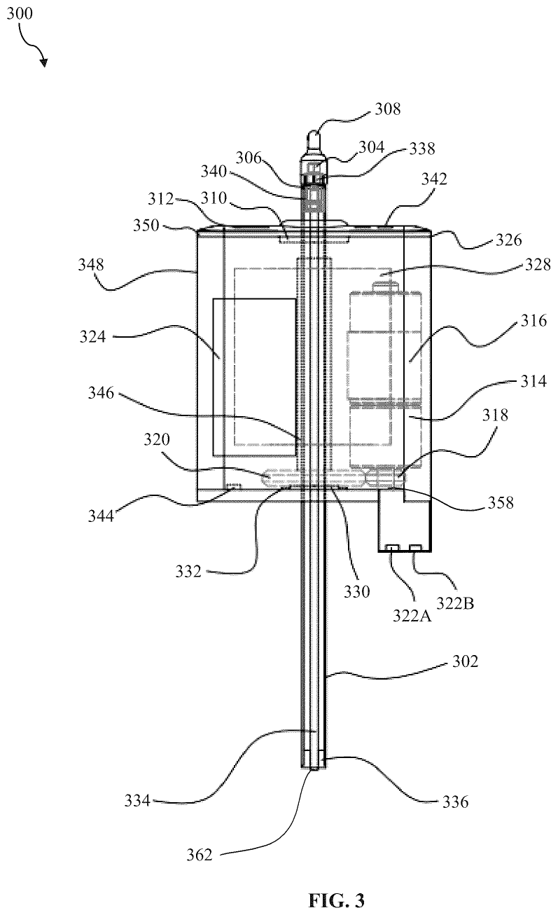

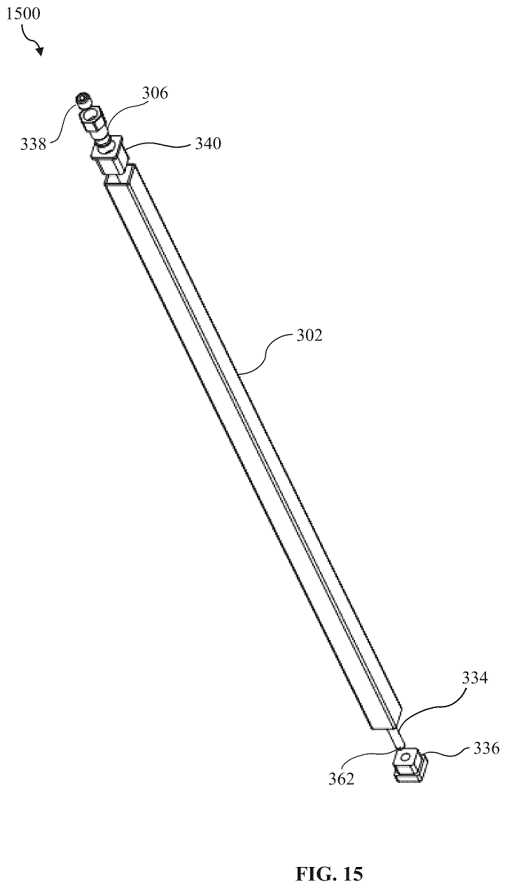

FIG. 3 is a schematic representation 300 illustrating a detailed view of the automatic stirring apparatus 102, such as those shown in FIG. 2 and FIG. 15, in accordance with an embodiment of the present disclosure. The detailed view of the automatic stirring apparatus 102 may include a hollow metal stirring shaft 302, a first round pogo pin type electrical connector 304 to electrically connect with a temperature probe 334, a cylindrical plastic combiner 306 which holds a second round pogo pin type electrical connector 338 (i.e., electrically connected to the temperature sensor 362 through wire) and top part of the temperature probe 334,, a metal U-shaped tubular type probe holder 308 houses the first round pogo pin type electrical connector 304 which is electrically connected through wires running inside the tubular structure of holder 308 and terminating at one or more controller printed circuit boards (PCB) 328, a first sealed ball bearing 310, a display with user interface 312, a reduction gear box 314, an output shaft 358 of the reduction gear box 314 rotating at approximately 260 revolutions per minute (RPM) with a rated load torque of 5 Kg-cm and maximum load torque of 60 Kg-cm, at least one first variable speed 12-volt direct current (DC) motor 316 mechanically attached to the input side of reduction gear box 314 a pinion gear 318 having a boss is fastened using set screws to the output shaft 358, a first reduction disk gear 320 meshingly connects with the pinion gear 318 to provide a rotational speed reduction ratio of 1:3, a stirring shaft holder tube 346 attached at the centre of the first reduction disk gear 320 together forms a rotor assembly, the rotational speed of the rotor assembly is approximately 86 revolutions per minute, one or more first camera devices 322A, one or more white light emitting diodes (LEDs) 322B, a first 12-volt lithium-ion battery pack 324 for supplying electrical power to the automatic stirring apparatus 102, a rubber gasket 326 to seal parts including stirring device enclosure 348 and stirring device enclosure lid 350, one or more controller printed circuit boards (PCB) 328, a second sealed ball bearing 330, a rubber gasket 332, a tubular stainless steel temperature probe 334 consisting an embedded temperature sensor 362 at its distal end, a first teflon bushing 336, two round pogo pin type electrical connector (304, 338), a second teflon bushing 340, one or more touch buttons 342, stirring apparatus locking cavity 344,, the stirring apparatus enclosure 348, and the stirring apparatus enclosure lid 350.

In an embodiment, the one or more controller printed circuit boards (PCB) 328 may include a first microcontroller that is configured to receive the one or more inputs from at least one of: the one or more first user interfaces of the one or more user devices 112 and the one or more touch buttons 342, of the automatic stirring apparatus 102, one or more second user interfaces and one or more touch screens, of the IoT based hand blender device 104, and one or more applications 110 configured in one or more user devices 112. In an embodiment, the one or more applications 110 configured in one or more user devices 112 may provide all necessary controls to the one or more users to control and monitor the IoT based food processing device. The display 312 is also a part of user interface which shows necessary information including controls and settings provided by the one or more users through the one or more touch buttons 342. In an embodiment, the one or more users may start/stop the stirring processes during the cooking process, increase/reduce the stirring speed, change the stirring direction (i.e., both clockwise and counterclockwise), turn ON/OFF the range hood fan, increase/reduce the range hood motor speed, control the brightness of the white LED, turn ON/OFF the one or more first camera devices 322A, capture one or more images, manually set the cooking timer, record the cooking process including all the sensor data, images and user inputs to save the recipe for future use or sharing, network (e.g., Wi-Fi) control, and the like.

The first microcontroller is further configured to receive at least one of: one or more images from one or more first camera devices 322A and one or more sensor data from one or more sensors configured in the automatic stirring apparatus 102. In an embodiment, the one or more sensors may include at least one of: the one or more temperature sensors 334 and one or more smoke sensors. In an embodiment, the one or more sensor data received from the one or more sensors include at least one of: one or more temperature data and one or more smoke data, associated with the one or more containers 204 during cooking and prepping of the one or more contents. The one or more images received from the one or more first camera devices 322A are processed with an image recognition technique to determine a type of the one or more contents present in the one or more containers.

The first microcontroller is further configured to transmit one or more signals to run the at least one first variable speed 12-volt direct current (DC) motor 316 to compute a load of the one or more contents in the one or more containers 204. The first microcontroller is further configured to match the one or more sensor data and the determined type of the one or more contents, with the computed load of the one or more contents to control speed and direction of rotation of the at least one first variable speed 12-volt direct current (DC) motor 316 for stirring the one or more contents in the one or more containers 204 using the stirring paddler device 202. In an embodiment, the first microcontroller may be programmed using one or more software languages to perform the above said processes as per desired product functionality.

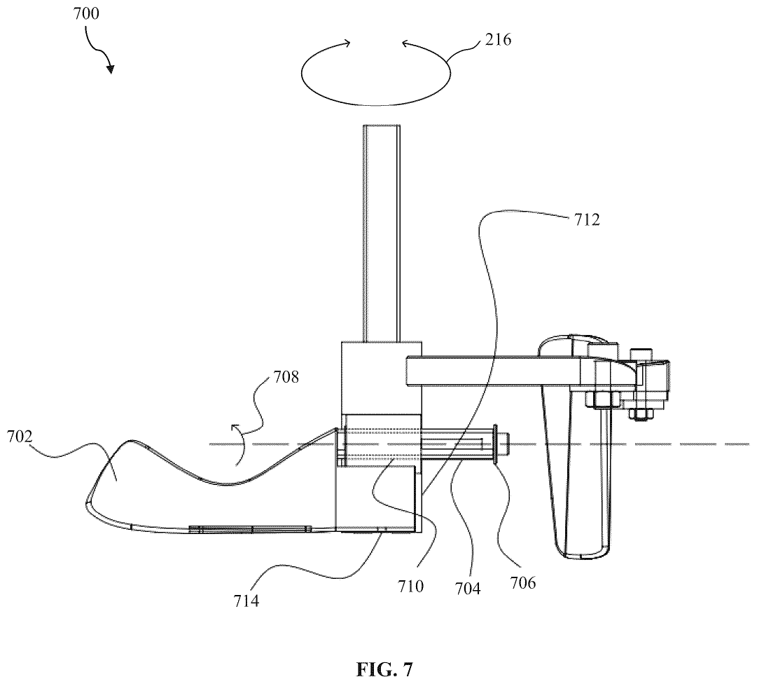

In an embodiment, the stirring shaft assembly 1500 (shown in FIG. 15) consisting of the stirring shaft 302 is mechanically connected to the at least one first variable speed 12-volt direct current (DC) motor 316 through at least one of: the pinion gear 318 and the rotor assembly formed by first reduction disk gear 320 and the stirring shaft holder tube 346, for rotating the stirring shaft 302. In an embodiment, the stirring paddler device 202 is mechanically connected to the stirring shaft 302 through a first coupler (shown in FIG. 7) for adapting the stirring paddler device 202 to stir the one or more contents in the one or more containers 204. The stirring shaft assembly 1500 is loosely fitted with by sliding the stirring shaft 302 inside the stirring shaft holder tube 346 of the rotor assembly to adapt for the height of one or more containers 204 during the cooking process.

In an embodiment, the one or more camera devices 322A are configured to capture the one or more images associated with the one or more contents in the one or more containers 204 using the image recognition technique. The one or more first camera devices 322A are further configured to transmit the one or more images associated with the one or more contents, to the first microcontroller. In an embodiment, the first microcontroller is configured to automatically set a cooking timer for a corresponding content in the one or more containers 204, based on one or more data inputs which includes at least one of: the one or more images received from the one or more first camera devices 322A, temperature sensor 334 data and load sensing data estimated by the first microcontroller consistently. In an embodiment, a proprietary algorithm is used to collect and process the data from above mentioned one or more sensors over a period with the user's approval. The algorithm may learn user's cooking method and preferences over time using machine learning (ML) and provide customized cooking time, temperature range, serving suggestions, recipes, and the like. In an embodiment, the first microcontroller is configured to automatically manage the control speed and direction of the rotation of the at least one first variable speed 12-volt direct current (DC) motor 316 for stirring the one or more contents in the one or more containers 204 using the stirring paddler device 202, based on the one or more images captured by the one or more first camera devices 322A and the one or more sensor data received from the one or more sensors. A white light emitting diode (LED) 322B is used to illuminate the one or more contents present in the one or more containers 204.

In an embodiment, the first microcontroller is configured to determine at least one of: burning, scorching, and sudden rise in surface temperature in the one or more containers 204 when at least one of: temperature and smoke, in the one or more containers 204 exceeds the pre-determined threshold value. The first microcontroller is further configured to send an alert to at least one of: the hand blender user interface 104 and the one or more user devices 112 associated with one or more users upon at least one of: burning, scorching, and sudden rise in surface temperature, in the one or more containers 204. In an embodiment, the first microcontroller is further configured to monitor the container's surface temperature, presence of contents and its amount present in the container 204, timer/time, high temperature alerts for burning or scorching of the container 204, free fall alert, motion detection and the like.

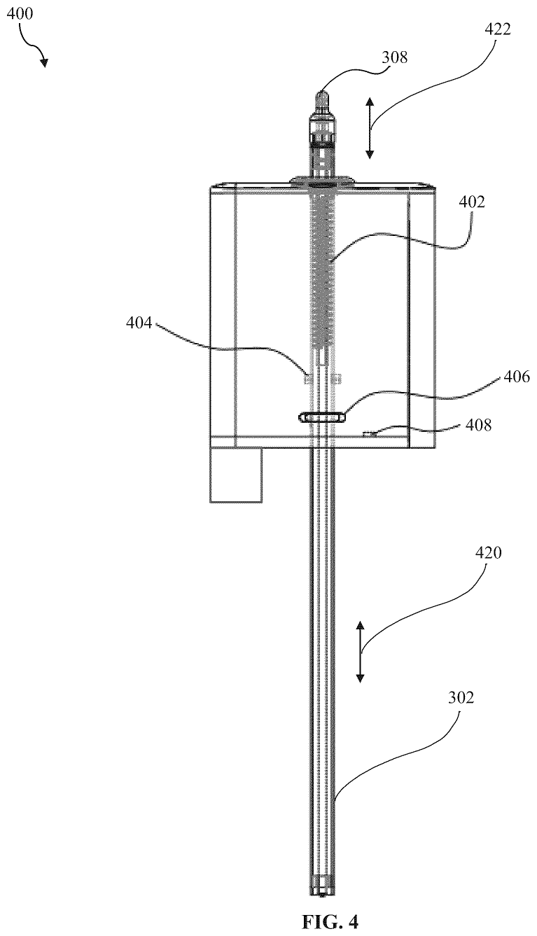

FIG. 4 is a schematic representation 400 illustrating one or more pogo pins 408 arranged in the automatic stirring apparatus 102, in accordance with an embodiment of the present disclosure. The automatic stirring apparatus 102 may further include a compression spring 402 loosely fitted along the length of the metal U-shaped tubular type probe holder 308 to hold and make electrical contact with the cylindrical plastic combiner 306 of the stirring shaft assembly 1500, the one or more pogo pins 406 for the range hood device 600, mounting protrusions 404 to freely mount the range hood device 600, arrow 422 showing the direction of motion of the metal U-shaped tubular type probe holder 308, arrow 420 and showing the direction of motion of the stirring shaft assembly 1500.

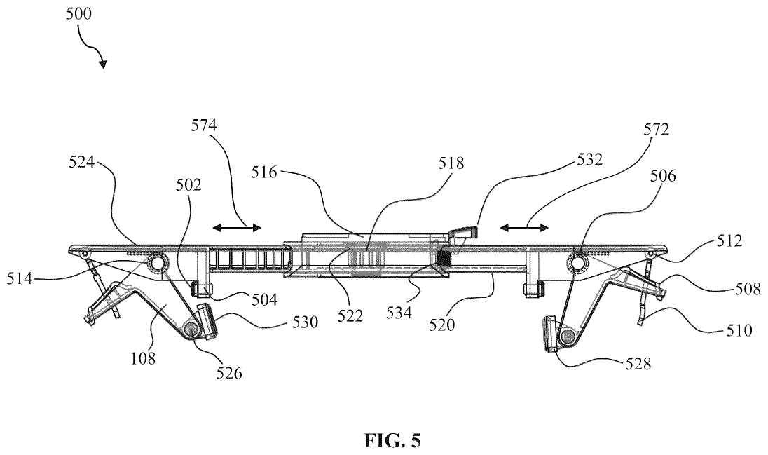

FIG. 5 is a schematic representation 500 illustrating the at least two clamping arms 106 with the at least two clamps 108, in accordance with an embodiment of the present disclosure. As discussed in FIG. 2, the at least two clamping arms 106 are configured to adapt for the slider motion of the automatic stirring apparatus 102. In an embodiment, the at least two clamping arms 106 may include the at least two clamps 108 configured to hold the one or more containers 204. In an embodiment, the at least two clamping arms 106 with the at least two clamps 108 are configured to be adjusted utilizing the slider motion based on size of the one or more containers 204.

The at least two clamping arms 106 may further include high temperature rubber grip 502 for holding the one or more containers 204, high temperature plastic protrusion 504 for holding the one or more containers 204, hinge 506 to unite at least one of: clamping arms handle 524 and the at least two clamps 108, hinge 526 to unite the at least two clamps 108 and clamp head 528, a rubber grip 530 for the clamp head 528, a locking latch 532, a compression spring 534 for the locking latch 532, gear rack 520 with a centre pinion gear 518 forming a rack and pinion type gear assembly, a circular mating part 522 to hold centre pinion gear in place, a clamping arms housing 516 consisting of a locking latch 532 and two slider rails on its top to mechanically slide and hold the stirring apparatus 102 at its centre, at least two clamping arms tension springs 514, arrows 572 and 574 showing the direction of the slider motion of the clamping arms 106, at least two metal locking bars 510 and metal mating parts 508 to form a ratchet type locking mechanism and at least two hinges 512 to unite metal locking bars 510 with clamping arms handle 524

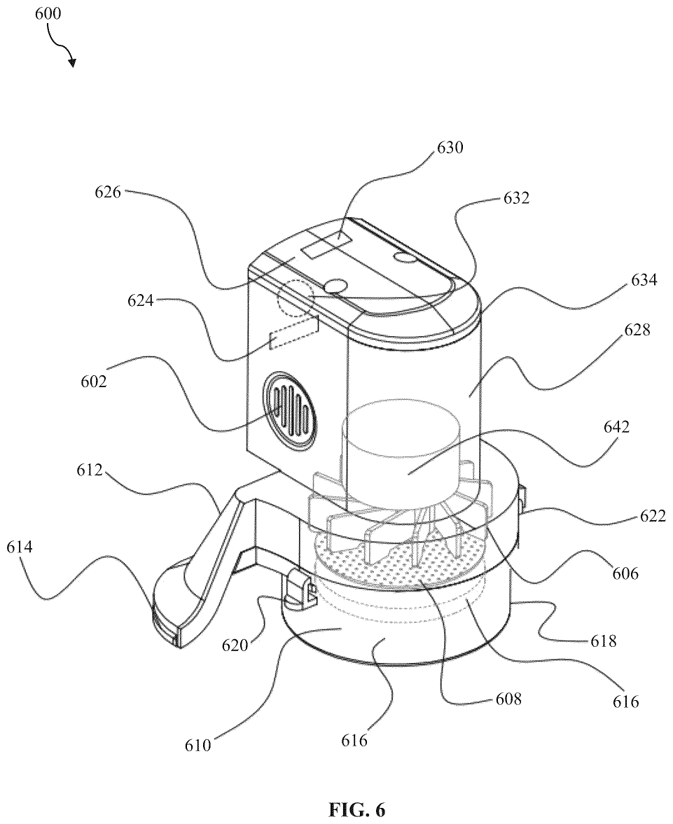

FIG. 6 is a schematic representation 600 of the range hood device (i.e., a miniature kitchen hood) which is freely mounted to back side of the automatic stirring apparatus 102, using one or more pogo pins 624, in accordance with an embodiment of the present disclosure. The schematic representation 600 of the range hood device depicts a plastic profile 602 for grip, the at least one second variable speed 12-volt direct current (DC) motor 642 with rotational speed of approximately 5000 revolutions per minute, a circulation fan 606, one or more smoke filter mesh 608, a smoke filter housing 610, top part of the air ventilation 612, bottom part of the air ventilation 614, an activated charcoal filter 616, a water collector bucket 618, a smoke filter housing lock 620, a smoke filter housing hinge 622, circulation fan motor housing lid 626, circulation fan motor housing 628, one or more pogo pins 624 placed at back side of the housing 628 to provide electrical power and control rotational speed of at least one second variable speed 12-volt direct current (DC) motor 642, one or more pogo pins 630 placed on top lid for accessory (i.e., atomiser transducer) electrical power and control, a neodymium magnet 632 for range hood device presence detection (i.e., using hall sensor), rubber gasket 634 for scaling the circulation fan motor housing lid 626 and the circulation fan motor housing 628.

In an embodiment, the circulation fan 606 is mechanically connected to the at least one second variable speed 12-volt direct current (DC) motor 642 for trapping/circulating heat, removing moisture, and filtering smoke/smell from the one or more containers 204 during cooking process. When a level of at least one of: temperature and smoke, of the one or more containers 204 exceeds one or more pre-determined threshold values, the second variable speed 12-volt direct current (DC) motor 642 speed is configured to control speed of the circulation fan 606 to vent the smoke and to provide warning/alerts to the one or more users In an embodiment, the range hood device may include an atomiser transducer device configured to spray one or more type of liquids in the one or more containers 204 to dissipate heat when at least one of: burning, scorching, and sudden rise in surface temperature in the one or more containers 204. The atomiser transducer device may be used in spraying liquid seasonings onto the contents in the one or more containers 204 at a pre-defined time interval.

FIG. 7 is a schematic representation 700 illustrating a stirring paddler device 202 with at least one scrapper stirring paddle for stirring the one or more contents in the one or more containers 204, in accordance with an embodiment of the present disclosure. The stirring paddler device 202 may include at least one primary stirring paddle 702, a primary stirring paddle arm 704, a stopper screw 706 attached to primary stirring paddle's arm, an arrow 708 showing the direction (i.e., both clockwise and counterclockwise) of the primary stirring paddle rotation, a coupler 712 (i.e., the first coupler) loosely fitted with the stirring shaft 302, a round hollow protrusion 710 in the coupler 712 for freely holding the primary stirring paddle arm 704, and a through hole 714 at the bottom of the coupler 712 to expose the temperature probe's 334 distal end.

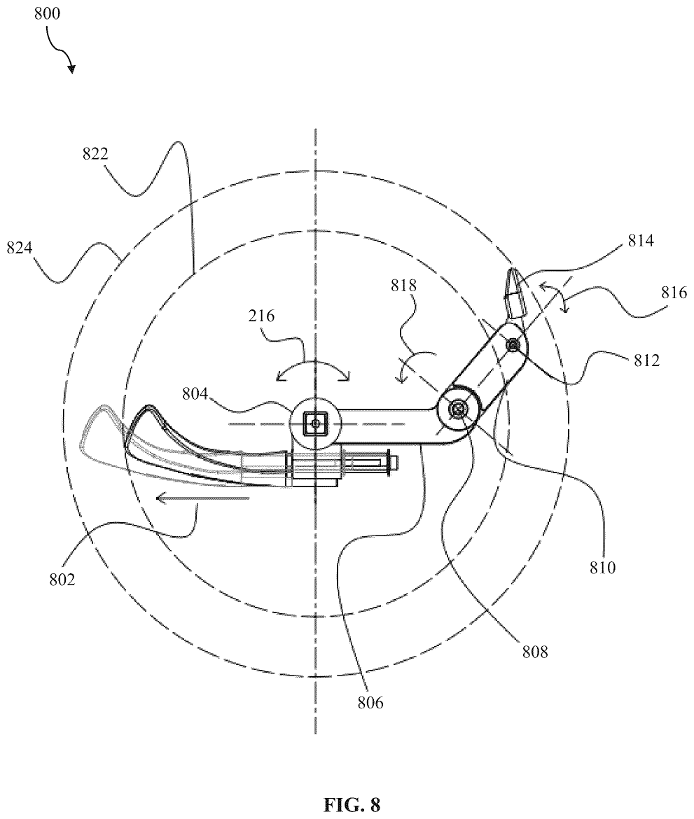

FIG. 8 is a top view 800 of the stirring paddler device 202 with the at least one scrapper stirring paddle 814 for stirring the one or more contents in the one or more containers 204, in accordance with an embodiment of the present disclosure. The top view 800 of the stirring paddler device 202 depicts an arrow 802 showing the direction of at least one primary stirring paddle 702 movement, a coupler 804 of a first stirring arm 806, a hinge 808 that unites the first stirring arm 806 and a second stirring arm 810, a hinge 812 that unites the second stirring arm 810 and the at least one scrapper stirring paddle 814, an arrow 816 showing the direction of rotation of the at least one scrapper stirring paddle 814, an arrow 818 showing the direction of rotation of the second stirring arm 810, an arrow 820 showing the direction of rotation of the at least one primary stirring paddle 702 and the first stirring arm 806, a small size 822 of the one or more containers 204, and a medium size of the one or more containers 204.

In an embodiment, the stirring paddler device 202 comprises at least one of: at least one primary stirring paddle 702 and at least one scrapper stirring paddle 814, for stirring the one or more contents in the one or more containers 204. In an embodiment, at least one of: the at least one primary stirring paddle 702 and the at least one scrapper stirring paddle 814, is mechanically connected to the coupler 804 for rotating at least one of: the at least one primary stirring paddle 702 and the at least one scrapper stirring paddle 814, to stir the one or more contents in the one or more containers 204. In an embodiment, the at least one primary stirring paddle 702 and the at least one scrapper stirring paddle 814 are configured to be adjusted to adapt the size of the one or more containers 204. In another embodiment, the at least one primary stirring paddle 702 and the at least one scrapper stirring paddle 814 are configured to adapt for at least one of: clockwise rotation and counterclockwise rotation, to evenly mix the one or more contents in the one or more containers 204.

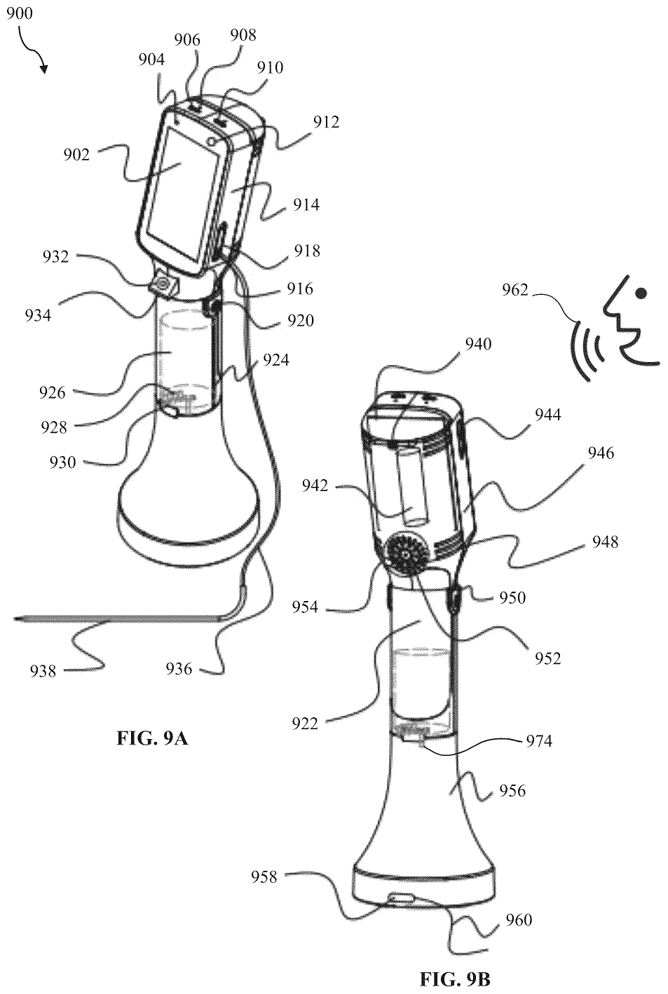

FIGS. 9A-9B are schematic representations depicting front and back view of an IoT based hand blender device 104 for processing the one or more contents in the one or more containers 204, in accordance with an embodiment of the present disclosure. The IoT based hand blender device 104 includes a display with a second user interface 902. The display with the second user interface 902 is placed adjacent to a handle and is visible to the one or more users for taking one or more commands using capacitive or resistive touch technology. In an embodiment, the display with the second user interface 902 through which the one or more inputs/commands are provided to a second microcontroller. In alternative embodiment, the one or more inputs/commands are provided to the second microcontroller through the one or more snap action switches and the one or more applications 110 of the one or more user devices 112.

The IoT based hand blender device 104 includes a microphone status led 904, a microphone power on/off button 906, two microphone holes 908 for microphone array utilized by artificial intelligence (AI) voice assistant software program configured by the second microcontroller, a hand blender primary power button 910, a clear glass window 912 for an ambient light sensor, a display enclosure 914, a content thermometer probe jack 916, a rubber lid 918, a hand blender motor left side power button 920, a hand blender handle with rubber grip 922, two vertical slots 924 on the handle 922 for mating with hand mixer or beater attachment 1300, at least one third variable speed 12-volt direct current (DC) motor 926 with rotational speed of approximately 18000 revolution per minute at its output shaft 974, one or more pogo pins 928 protruding out of the hand blender's base for charging and communication, a hand blender tooling lock button 930, one or more second camera devices 932 for image recognition, a movable (e.g. rotatable on an axis) camera with a LED (Light Emitting Diode) housing 934, a thermometer probe wire 936, a thermometer probe 938, one or more controller printed circuit boards (PCB) 940, a second lithium-ion 12-volt battery pack 942 for supplying electrical power to the IoT based hand blender device 104, an SD card slot 944 for storage data, a hand blender enclosure back side 946, cooling air ventilation 948, a hand blender motor right side power button 950, speaker holes 952, a speaker 954 for audio output, a charger docking base 956, a charging port 958, and a charging wire 960. In an embodiment, the hand blender primary power button 910 may be configured to turn ON the system power for the IoT based hand blender device 104.

The second microcontroller is configured to control speed of at least one third variable speed 12-volt direct current (DC) motor 926 to process the one or more contents based on the one or more inputs received from at least one of: the one or more second user interfaces 902 and the one or more snap action switches, of the internet of things (IoT) based hand blender device, and the one or more applications 110 configured in one or more user devices 112. In an embodiment, the second microcontroller may be programmed using one or more software languages to perform the above said processes as per desired product functionality.

In an embodiment, the one or more second camera devices 932 are configured to capture the one or more contents to determine one or more types of the one or more contents using the image recognition technique.

In an embodiment, two microphone holes 908 placed in-line with the two Micro-Electro-Mechanical Systems (MEMS) microphone's sound inlet cavity are utilized by artificial intelligence (AI) voice assistant software program configured by the second microcontroller. The display with the one or more second user interfaces 902 shows the information or response of the artificial intelligence (AI) voice assistant software as prompted by one or more user voice commands 962.

In an embodiment, the one or more locking buttons (i.e., the hand blender tooling lock button) 930 are configured to connect to at least one of: one or more content processing tools and the food processor attachment. In an embodiment, the one or more locking buttons (i.e., the hand blender tooling lock button) 930 connected to the one or more content processing tools are configured to control the one or more content processing tools when the one or more content processing tools are required to process.

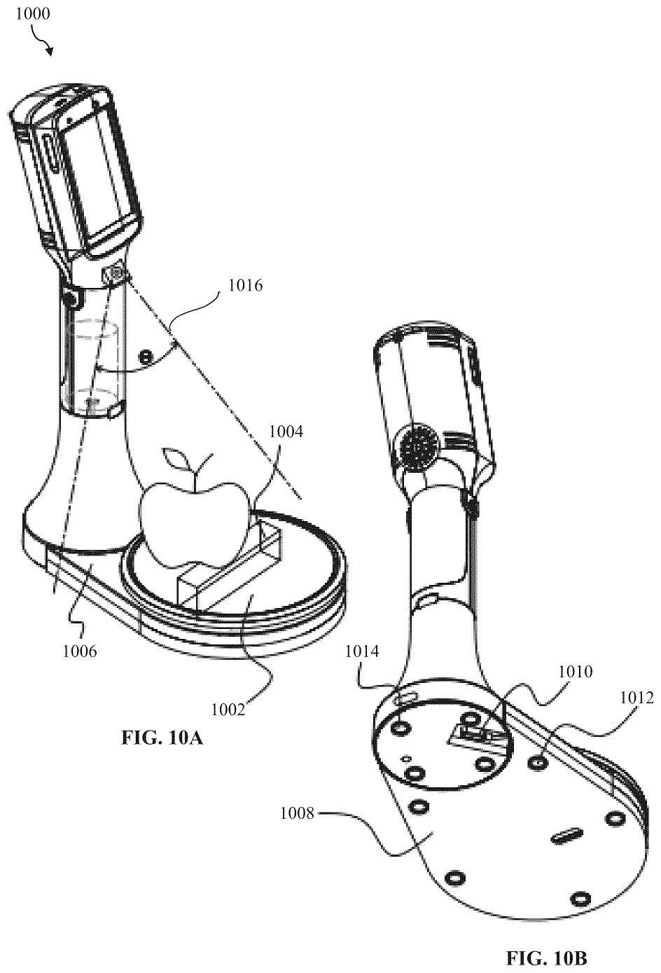

FIGS. 10A-10B are schematic representations depicting the IoT based hand blender device 104 with a kitchen scales attachment 1000 for weighing the one or more contents, in accordance with an embodiment of the present disclosure. The kitchen scales attachment 1000 may include one or more weighing sensors (i.e., a load cell) 1004 and the kitchen scales attachment enclosure top cover 1006. The kitchen scales attachment 1000 is electrically connected, through one or more pogo pin connectors 1010, to the internet of things (IoT) based hand blender device 104 for weighing the one or more contents placed on a weighing tray 1002 using the one or more weighing sensors 1004 attached with the weighing tray 1002. The bottom view of the IoT based hand blender device 104 depicts a kitchen scales attachment enclosure base 1008, the one or more pogo pin connectors 1010, kitchen scales attachment resting legs 1012 and charging dock resting legs 1014 for the IoT based hand blender device 104. The camera field of view 1016 (i.e., θ=70 degrees) is shown to be focusing on the one or more content placed on the weighing tray 1002 for taking the one or more images by the one or more second camera devices 932 for image recognition.

In an embodiment, the one or more pogo pins 928 are electrically connected to the kitchen scales attachment 1000 through one or more pogo pin connectors 1010, to weigh the one or more contents and to communicate the weightage of the one or more contents to the one or more second user interfaces 902 through the second microcontroller.

In an embodiment, the one or more weighing sensors 1004 are configured to provide one or more electrical data associated with the weightage of the one or more contents, to the internet of things (IoT) based hand blender device 104 to compute one or more nutrition values in the one or more contents. The second microcontroller in the internet of things (IoT) based hand blender device 104 is configured to obtain the one or more electrical data associated with the weightage of the one or more contents. The second microcontroller is further configured to compare the one or more electrical data associated with the weightage of the one or more contents, with one or more pre-determined data associated with the one or more nutritional values in the one or more contents. The second microcontroller is further configured to capture the one or more images using the one or more second camera devices 932 to determine one or more types of contents using the image recognition technique. The determined one or more content type data is used to compute the one or more nutritional values in the one or more contents based on the comparison of the one or more electrical data associated with the weightage of the one or more contents, with the one or more pre-determined data associated with the one or more nutritional values in the one or more contents.

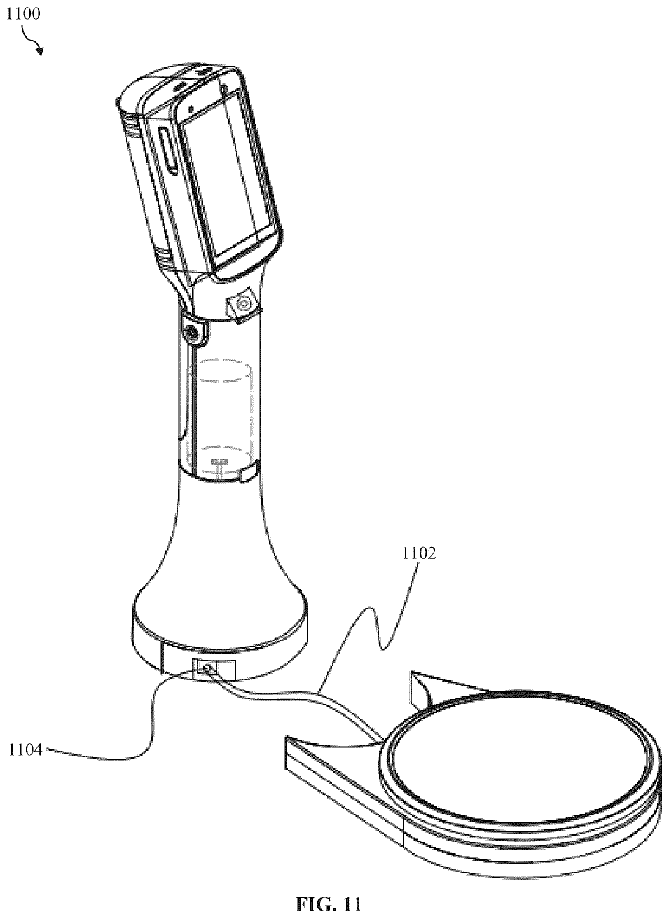

FIG. 11 is a schematic representation 1100 depicting the IoT based hand blender device 104 with the kitchen scales attachment 1000 through a communication wire 1102, in accordance with an embodiment of the present disclosure. In an embodiment, the kitchen scales attachment 1000 is freely moved, using the communication wire 1102 (e.g., an electrical wire), to accommodate one or more sizes of the one or more containers for weighing the one or more containers. In an embodiment, the kitchen scales attachment 1000 in connection with the internet of things (IoT) based hand blender device 104, is configured to at least one of: create one or more recipes and follow a guided cooking.

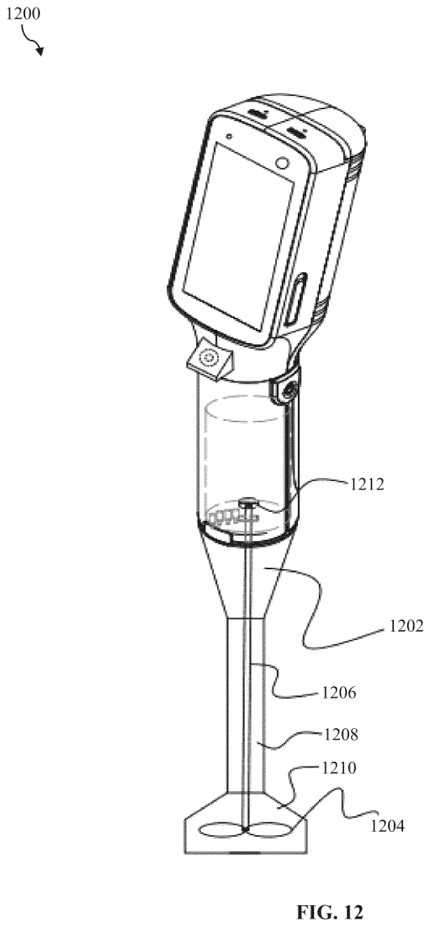

FIG. 12 is a schematic representation 1200 depicting the IoT based hand blender device 104 coupled with one or more blender blades 1204 through a shaft 1206 and a coupler 1212 in accordance with an embodiment of the present disclosure. The schematic representation 1200 of the IoT based hand blender device 104 further depicts a hand blender blades tool coupler 1202, a shaft cover 1208, and a top cover 1210 for the one or more blades 1204. The rotational capacity of the one or more blades 1204 is approximately 14500 revolutions per minute.

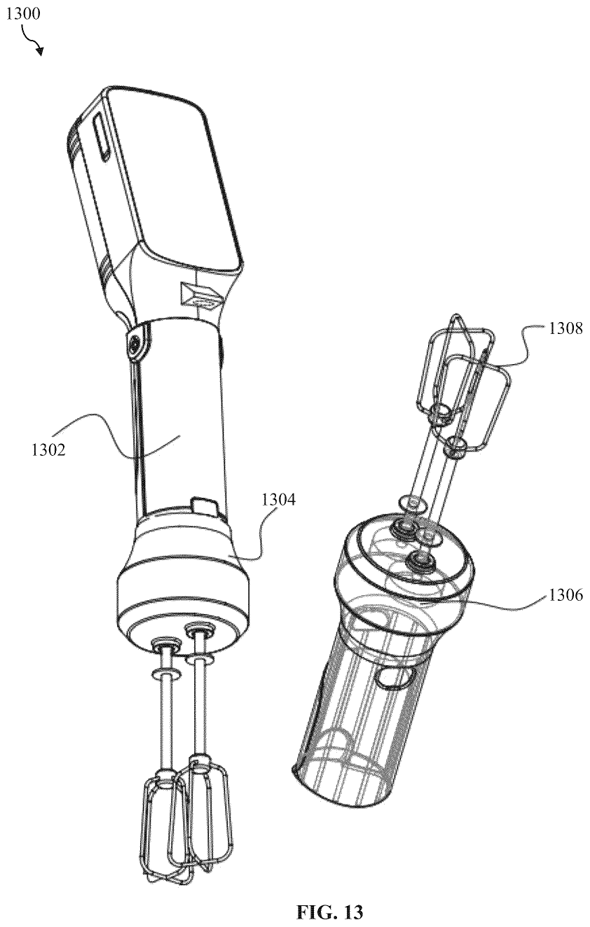

FIG. 13 is a schematic representation 1300 depicting the IoT based hand blender device 104 coupled with a mixer or beater attachment 1308 using one or more third reduction gears 1306, in accordance with an embodiment of the present disclosure. The IoT based hand blender device 104 may include a hand mixer attachment handle 1302 and a hand mixer attachment gear box cover 1304. The hand mixer attachment handle 1302 is hollow and slides over the IoT based hand blender device's handle 922 using the two vertical slots 924. In an embodiment, the at least one third variable speed 12-volt direct current (DC) motor's 926 output shaft 974 is mechanically connected with the coupler (i.e., a second coupler) 1212, which protrudes out of a housing of the internet of things (IoT) based hand blender device 104 and gets mechanically attached to one or more third reduction gears 1306 to drive the beater attachment 1308.

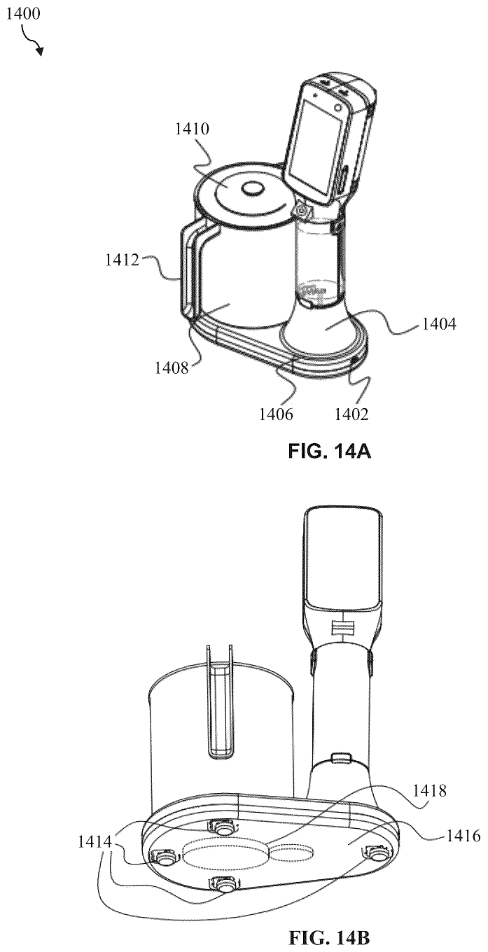

FIGS. 14A-14B are schematic representations 1400 depicting the IoT based hand blender device 104 coupled with a food processor attachment 1400 to drive the food processor attachment 1400 using one or more second reduction gears 1418, in accordance with an embodiment of the present disclosure. The IoT based hand blender device 104 coupled with the food processor attachment 1400 may depict a charging connector 1402 for the IoT based hand blender device 104, a charging dock base 1404, an enclosure top part 1406 of the food processor attachment 1400, a food processor container 1408, a food processor container lid 1410, a food processor container handle 1412, the one or more load cells (e.g., the one or more weighing sensors) 1414, a bottom part 1416 of the food processor attachment 1400, and the one or more second reduction gears 1418. In an embodiment, the at least one third variable speed 12-volt direct current (DC) motor 926 is mechanically connected using the coupler 1212 to the one or more second reduction gears 1418 to drive the food processor container 1408. In an embodiment, four weighing sensors (i.e., load cells) 1414 are electrically connected using the one or more pogo pins 928 to the internet of things (IoT) based hand blender device 104 for weighing the one or more contents placed on the food processor container 1408. The weighing sensors 1414 are configured to provide one or more electrical data associated with the weightage of the one or more contents, to the internet of things (IoT) based hand blender device 104 to compute the one or more nutritional values in the one or more contents. The second microcontroller in the internet of things (IoT) based hand blender device 104 is configured to obtain the one or more electrical data associated with the weightage of the one or more contents. The second microcontroller is further configured to compare the one or more electrical data associated with the weightage of the one or more contents, with one or more pre-determined data associated with the one or more nutritional values in the one or more contents. The second microcontroller is further configured to compute the nutrition in the one or more contents based on the comparison of the one or more electrical data associated with the weightage of the one or more contents, with the one or more pre-determined data associated with the one or more nutritional values in the one or more contents.

FIG. 15 is an exploded view representation 1500 depicting the stirring shaft assembly which comprises of a hollow metal stirring shaft 302, a second pogo pin type electrical connector 338, a tubular stainless steel temperature probe 334, an embedded temperature sensor 362 located at the distal end of the temperature probe 334, a cylindrical plastic combiner 306 which holds the second round pogo pin type electrical connector 338 and the top part of temperature probe 334, the second round pogo pin type electrical connector 338 is electrically connected to the temperature sensor 362 through wires running inside the tubular structure of the temperature probe 334, a first teflon bushing 336 present at the end of the stirring shaft 302 and a second teflon bushing 340 present at the beginning of the stirring shaft 302, in accordance with an embodiment of the present disclosure.

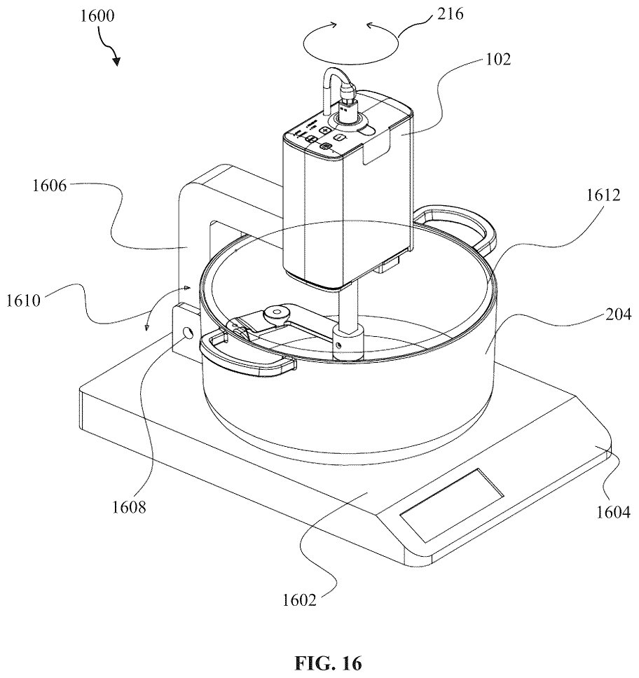

FIG. 16 is a schematic representation 1600 depicting a companion apparatus connected to the automatic stirring apparatus 102, in accordance with an embodiment of the present disclosure. The schematic representation of the companion apparatus depicts an induction cooktop device 1602 with inbuilt thermometer for measuring surface temperature. The schematic representation 1600 of the companion apparatus further depicts four legs 1604 fitted with one or more load sensors for weighing the one or more contents in the one or more containers 204. The schematic representation 1600 of the companion apparatus further depicts a mounting arm 1606 which holds the automatic stirring apparatus 102. The schematic representation 1600 of the companion apparatus further depicts a hinge 1608 that is configured to connect the mounting arm 1606 and the induction cooktop device 1602.

The schematic representation 1600 of the companion apparatus further depicts a direction of rotation of the mounting arm 1606. The schematic representation 1600 of the companion apparatus further depicts a lid 1612 that is placed on top of the container 1614 and is freely attached to the mounting arm 1606. In an embodiment, the one or more containers 204 may be of various sizes. In an embodiment, the companion apparatus is electrically connected to the automatic stirring apparatus 102 using the one or more pogo pins 408. In another embodiment, the companion apparatus is wirelessly connected to the automatic stirring apparatus 102 using at least one of: a wireless fidelity (WiFi) and Bluetooth technology.

In an embodiment, the automatic stirring apparatus 102 being connected with the companion apparatus, collects the one or more data including at least one of: the one or more user inputs, the one or more sensor data, one or more images to compute cooking time, cooking temperature, stirring speed and direction of the rotation. The companion device/apparatus connected with the automatic stirring apparatus 102 may perform automatic food type detection, automatic surface temperature control, automatic ON/OFF of the cooktop heating element, automatically setting the cooking time and temperature, nutrition estimation, stirring speed and direction of the rotation control. In an embodiment, the mounting arm 1606 may adjust in height to adapt various container sizes. Further, the companion apparatus may be attached with one or more actuators to automatically dispense the one or more contents into the one or more containers 204.

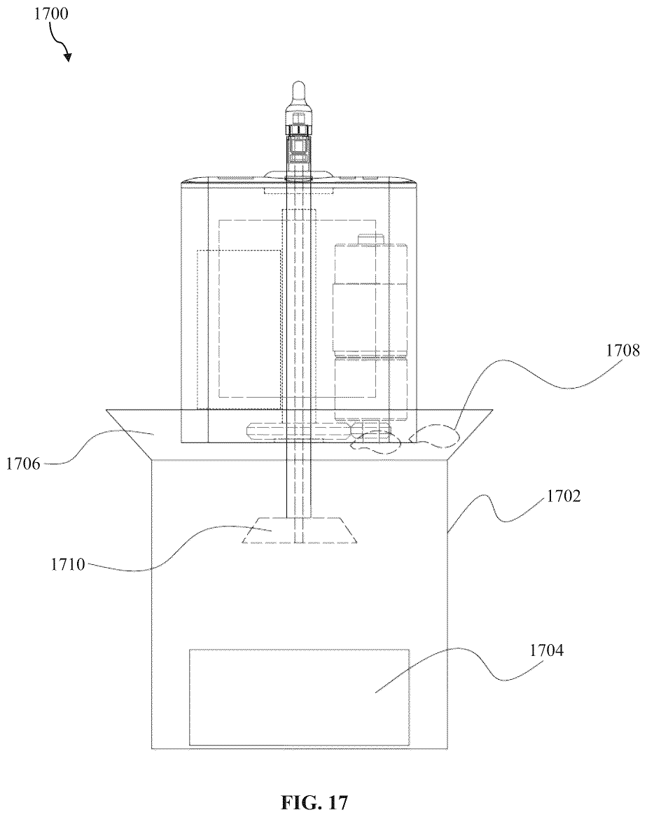

FIG. 17 is a schematic representation 1700 depicting a grinder attachment connected to the automatic stirring device 102, in accordance with an embodiment of the present disclosure. In an embodiment, the grinder attachment may be at least one of: a coffee grinder attachment and a spice grinder attachment. The schematic representation 1700 of the grinder attachment includes a housing 1702 with a collector bin 1704. The grinder attachment further includes a feeder 1706 to place the one or more contents (e.g. coffee beans or spices) 1708 for grinding. In an embodiment, the one or more contents 1708 may be placed in the feeder 1706 for processing. The schematic representation 1700 of the grinder attachment further includes a burr 1710 to grind the one or more contents 1708. The user places the one or more contents 1708 in the feeder 1706 and provides one or more inputs to the automatic stirring device 102 using the one or more touch buttons 342 through the user interface 312. The one or more contents 1708 are grinded using the burr 1710 and collected in the collector bin 1704.

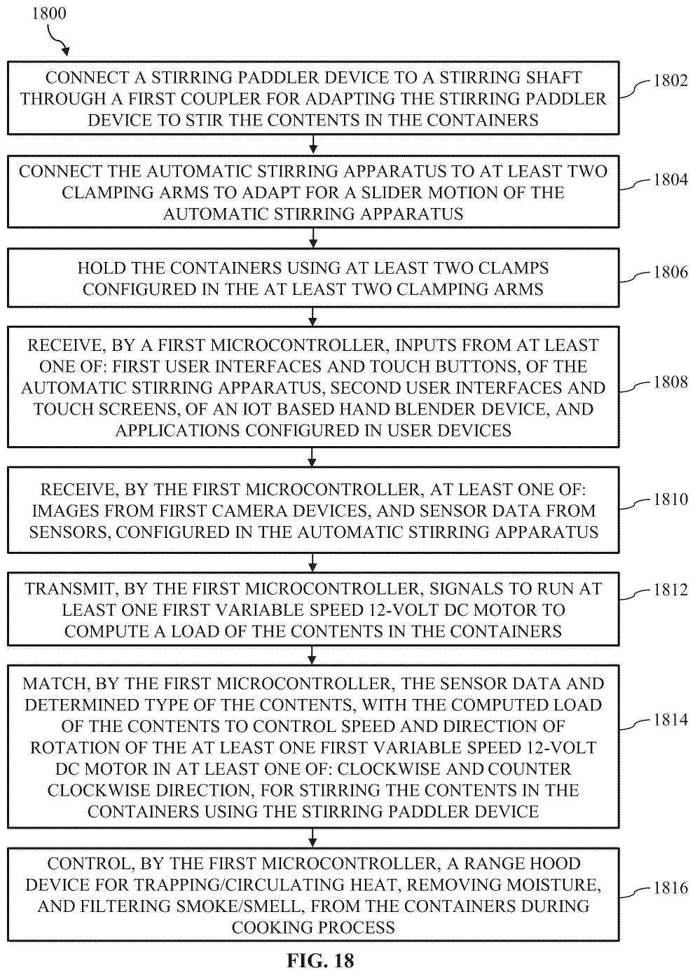

FIG. 18 is a flow chart illustrating an Internet of Things (IoT) based food processing method 1800 for automated cooking and prepping of one or more contents in the one or more containers 204 using the automatic stirring apparatus, in accordance with an embodiment of the present disclosure.

At step 1802, the stirring paddler device 202 is connected to the stirring shaft 302 through the first coupler 712 for adapting the stirring paddler device 202 to stir the one or more contents in the one or more containers 204.

At step 1804, the automatic stirring apparatus 102 is connected to at least two clamping arms 106 to adapt for a slider motion of the automatic stirring apparatus 102. In an embodiment, the automatic stirring apparatus 102 is configured to be mounted on a top of the one or more containers 204 by utilizing at least two clamping arms 106 with at least two clamps 108 and placing it over the stirrer assembly 700.

At step 1806, In an embodiment, at least two clamping arms 106 may include the at least two clamps 108 configured to hold the one or more containers 204. In an embodiment, the at least two clamping arms 106 with the at least two clamps 108 are configured to be adjusted based on size of the one or more containers 204.

At step 1808, the one or more inputs are received at the first microcontroller, from at least one of: the one or more first user interfaces and the one or more touch buttons, of the automatic stirring apparatus 102, the one or more user interfaces and touch screen, of the hand blender apparatus 104, and the one or more applications 110 configured in the one or more user devices 112.

At step 1810, at least one of: the one or more images and the one or more sensor data are received at the first microcontroller, from the one or more first camera devices 322A and the one or more sensors respectively, configured in the automatic stirring apparatus 102. The one or more sensor data received from the one or more sensors may include at least one of: the one or more temperature data and the one or more smoke data, associated with the one or more containers 204 during cooking and prepping of the one or more contents. The one or more images received by the first microcontroller, are processed with the image recognition technique to determine the content type present in the one or more containers 204.

At step 1812, the one or more signals are transmitted from the first microcontroller to run the at least one first variable speed 12-volt direct current (DC) motor 316 to compute the load of the one or more contents in the one or more containers 204.

At step 1814, the one or more sensor data and estimated content type (i.e., the content type determined by the image recognition technique) are matched with the computed load of the one or more contents to control speed and direction of rotation of the at least one first variable speed 12-volt direct current (DC) motor 316 in at least one of: clockwise or counter clockwise direction, for stirring the one or more contents in the one or more containers 204 using the stirring paddler device 202.

At step 1816, the range hood device 600 is controlled by the first microcontroller for consistently trapping/circulating heat, removing moisture, and filtering smoke/smell from the one or more containers 204 during cooking process. When the level of at least one of: temperature and smoke, of the one or more containers 204 exceeds one or more pre-determined threshold values, the at least one second variable speed 12-volt direct current (DC) motor 642 speed is configured to control the circulation fan 606 to vent the smoke and to provide warning/alerts to the one or more users

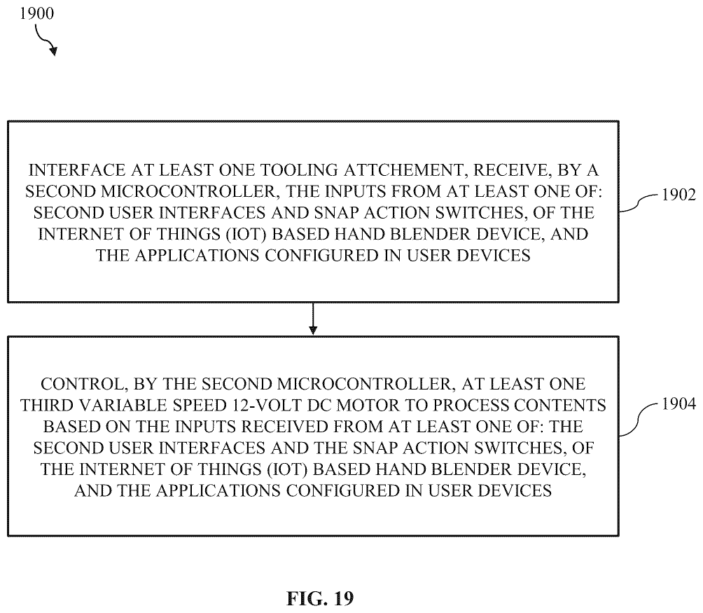

FIG. 19 is a flow chart illustrating the Internet of Things (IoT) based food processing method 1900 for cooking and prepping of the one or more contents in the one or more containers 204 using the internet of things (IoT) based hand blender device 104, in accordance with an embodiment of the present disclosure.

At step 1902, a tooling attachment (i.e., kitchen scales 1000, blender blades 1200, mixer or beater 1300, food processor 1400) is mechanically interfaced with the internet of things (IoT) based hand blender device 104, the one or more inputs are received at the second microcontroller, from at least one of: the one or more second user interfaces 902 and the one or more snap action switches, of the internet of things (IoT) based hand blender device 104, and the one or more applications 110 configured in the one or more user devices 112.

At step 1904, at least one third variable speed 12-volt direct current (DC) motor 926 are controlled by the second microcontroller to process the one or more contents based on the one or more inputs received from at least one of: the one or more second user interfaces 902 and the one or more snap action switches, of the internet of things (IoT) based hand blender device 104, and the one or more applications 110 configured in the one or more user devices 112. In an embodiment, cooking and prepping of the one or more contents in the one or more containers may include at least one of: mixing, blending, chopping, grinding, crushing, whisking, frothing, kneading, of the one or more contents in the one or more containers.

The present invention has following advantages. The present invention focuses on stirring both solid and fluid food contents using high power motor and batteries with constant environment sensing using the temperature probe 334, the camera devices (322A, 932) and load feedback to estimate the quantity of food to be cooked. The present invention with the IoT based food processing device is fully automatic and may also be manually controlled by the one or more users. The IoT based food processing device may learn individual's cooking methods and needs over time, and suggest the optimal temperature, cooking time, serving size suggestions based upon contents or nutritional needs and the like. A dedicated display on the IoT based hand blender device 104 may provide necessary information of on-going process and may be used for at least AI voice assistant, IoT home assistant, nutrition counting, food processor, BBQ temperature probe, and the like.

The present invention with the portable IoT based food processing device uniquely unites the automatic stirring apparatus 102, the IoT based hand blender device 104 with its one or more blender blades attachment 1200, the food processor attachment 1400, hand mixer or beater attachment 1300, the kitchen scales attachment 1000, and the like. The automatic stirring apparatus 102 mounted on top of the one or more containers 204, is configured to perform continuous temperature sensing of the cooking surface while wirelessly being connected to internet/user device 112, automating the cooking process by food type detection and self-adjusting the stirring speed and direction, performing heat trap and smoke/smell removal The one or more second user interfaces 902 are also used in conjunction with the user interface 312 on the automatic stirring apparatus 102 for displaying all the necessary information to control and monitor the automatic stirring apparatus 102. The IoT based hand blender device 104 is configured to perform at least image recognition, nutrition estimation with serving size information, artificial intelligence voice assistant, food processing, BBQ temperature probe, and the like. The present invention maybe configured to adapt the one or more users to command the automatic stirring apparatus 102 to start stirring in at least one of: automatic mode with no user intervention, a manual mode with some intervention, a guided cooking process, a recording recipe mode to record cooking processes of the one or more users, and the like.

The one or more applications 110 may be used to allow the one or more users to provide the inputs for controlling and monitoring the portable IoT based food processing device. In conjunction with the IoT based food processing device, a number of software activities including at least one of: machine learning, digitizing the cooking process, learning the user's cooking methods/flows, user interaction/interface, user profile, recipe creation or editing, sharing the recipes, creating the grocery list, ordering grocery, meal services and the like, may be performed using the one or more applications 110.

The present invention may be used in chemical engineering setting to mix and stir liquids and solid compounds. The present invention may be utilized in other industrial, laboratory, civil, outdoor activity and household tooling tasks including at least one of: drilling, cutting, sanding, buffing, mixing and similar tasks, which require a rotary apparatus with a gearbox and/or a tooling attachment. The present invention may be used in one or more fields including at least one of: paint mixing, tile tools, power tools, stirrers and mixers accessories, environmental protection, health, medicine, metallurgy and chemistry.

The present invention may utilize an infrared (IR) camera/sensor being configured in the automatic stirring apparatus 102 for contactless temperature measurement of the one or more contents in the one or more containers 204, which provides more advanced options to the IoT based food processing device to meticulously monitor the surface temperature of the one or more contents while the thermal probe simultaneously measures the temperature of the base of the one or more containers 204.

The present invention may further be used to create one or more tools including at least one of: one or more rotary tools, a cordless drill, a waxer/polisher, a lab electric overhead stirrer, paint stirrer/mixing, a vacuum pump, AI voice/home assistant, indoor security camera monitor, coffee grinder, spice grinder, alarm clock, citrus juicer machine and the like.

To use the IoT based hand blender device 104, the battery is charged and one or more desired tools (e.g., one or more blender blades, chopping blades, whisk, and the like) are attached. For processing one or more tasks using the IoT based hand blender device 104, a handle of the IoT based hand blender device 104 is placed in vertical position keeping the user interface on top, facing the user interface towards the one or more users. The one or more users unlock the snap action switch and perform the one or more tasks by pressing the button. The food processor attachment) 1400 comprising the food processor container 1408 may be used to at least one of: chop, puree, shred, knead, weight the one or more contents for nutrition, and the like. In an embodiment, food processing type may be selected on the second user interface 902 for appropriate use.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the food processing device either directly or through intervening I/O controllers. Network adapters may also be coupled to the food processing device to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/food processing device in accordance with the embodiments herein. The food processing device herein comprises at least one processor or central processing unit (CPU). The CPUs are interconnected via a system bus to various devices including at least one of: a random-access memory (RAM), read-only memory (ROM), and an input/output (I/O) adapter. The I/O adapter can connect to peripheral devices, including at least one of: disk units and tape drives, or other program storage devices that are readable by the food processing device. The food processing device can read the inventive instructions on the program storage devices and follow these instructions to execute the methodology of the embodiments herein.

The food processing device further includes a user interface adapter that connects a keyboard, mouse, speaker, microphone, and/or other user interface device including a touch screen device (not shown) to the bus to gather user input. Additionally, a communication adapter connects the bus to a data processing network, and a display adapter connects the bus to a display device which may be embodied as an output device including at least one of: a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that are issued on an application based here on. Accordingly, the embodiments of the present invention are intended to be illustrative, but not limiting, of the scope of the invention, which is set forth in the following claims.

What is claimed is:

1. A portable Internet of Things (IoT) based food processing device for automated cooking and prepping of one or more contents in one or more containers, the portable Internet of Things (IoT) based food processing device comprising:
a stirring paddler device connected to a stirring shaft through a first coupler for adapting the stirring paddler device to stir the one or more contents in the one or more containers;
an automatic stirring apparatus configured to connect to at least two clamping arms to adapt for a slider motion of the automatic stirring apparatus, wherein the automatic stirring apparatus is configured to be mounted on a top of the one or more containers by utilizing the at least two clamping arms with at least two clamps and by placing the automatic stirring apparatus over a stirrer assembly,
wherein the at least two clamping arms comprise the at least two clamps configured to hold the one or more containers, and wherein the at least two clamping arms with the at least two clamps are configured to be adjusted based on size of the one or more containers,
wherein the automatic stirring apparatus comprises:
a first microcontroller in one or more controller printed circuit boards (PCB) configured to:
receive one or more inputs from at least one of: one or more first user interfaces and one or more touch buttons, of the automatic stirring apparatus, one or more second user interfaces and one or more touch screens, of an internet of things (IoT) based hand blender device, and one or more applications configured in one or more user devices;
receive at least one of: one or more images from one or more first camera devices and one or more sensor data from one or more sensors configured in the automatic stirring apparatus, wherein the one or more sensor data received from the one or more sensors comprise at least one of: one or more temperature data and one or more smoke data, associated with the one or more containers during cooking and prepping of the one or more contents and wherein the one or more images received from the one or more first camera devices are processed with image recognition technique to determine a type of the one or more contents present in the one or more containers;
transmit one or more signals to run at least one first variable speed 12-volt direct current (DC) motor to compute a load of the one or more contents in the one or more containers; and
match the one or more sensor data and the determined type of the one or more contents, with the computed load of the one or more contents to control speed and direction of rotation of the at least one first variable speed 12-volt direct current (DC) motor in at least one of: clockwise and counterclockwise direction, for stirring the one or more contents in the one or more containers using the stirring paddler device; and
a range hood device freely attached to the automatic stirring apparatus using one or more pogo pins, wherein the range hood device comprises a circulation fan mechanically connected to at least one second variable speed 12-volt direct current (DC) motor, wherein the range hood device is controlled by the first microcontroller for at least one of: circulating heat, removing moisture, and filtering smoke, from the one or more containers during cooking process using the circulation fan, and
wherein the at least one second variable speed 12-volt direct current (DC) motor is configured to control speed of the circulation fan to vent the smoke and to provide one or more alerts to the one or more users, when a level of at least one of: temperature and the smoke, of the one or more containers exceeds one or more pre-determined threshold values.

2. The portable Internet of Things (IoT) based food processing device of claim 1, wherein the one or more first camera devices are configured to:
capture the one or more images associated with the one or more contents in the one or more containers using the image recognition technique; and
transmit the one or more images associated with the one or more contents, to the first microcontroller,
wherein the first microcontroller is configured to:
automatically set a cooking timer for a corresponding content in the one or more containers, based on the one or more images received from the one or more first camera devices;
automatically mange the control speed and direction of the rotation of the at least one first variable speed 12-volt direct current (DC) motor for stirring the one or more contents in the one or more containers using the stirring paddler device, based on the one or more images captured by the one or more first camera devices and the one or more sensor data received from the one or more sensors.

3. The portable Internet of Things (IoT) based food processing device of claim 1, wherein the range hood device further comprises:
an atomiser transducer device configured to spray one or more type of liquids in the one or more containers to dissipate heat when at least one of: burning, scorching and sudden rise in surface temperature of the one or more containers, wherein the automizer transducer device is configured for spraying liquid seasonings, onto the one or more contents in the one or more containers at a pre-defined time interval.

4. The portable Internet of Things (IoT) based food processing device of claim 1, wherein the stirring paddler device comprises at least one of: at least one primary stirring paddle and at least one scrapper stirring paddle, for stirring the one or more contents in the one or more containers, and wherein at least one of: the at least one primary stirring paddle and the at least one scrapper stirring paddle, is mechanically connected to the first coupler,
wherein the at least one primary stirring paddle and the at least one scrapper stirring paddle are configured to be adjusted to adapt the size of the one or more containers, and
wherein the at least one primary stirring paddle and the at least one scrapper stirring paddle are configured to adapt for at least one of: clockwise rotation and counterclockwise rotation, to mix the one or more contents in the one or more containers.

5. The portable Internet of Things (IoT) based food processing device of claim 1, wherein the first microcontroller is configured to:
determine at least one of: burning, scorching, and sudden rise in the surface temperature, in the one or more containers when at least one of: temperature and smoke, in the one or more containers exceeds the pre-determined threshold value; and
send an alert to the one or more user devices associated with one or more users upon at least one of: burning, scorching, and sudden rise in the surface temperature, in the one or more containers.

6. The portable Internet of Things (IoT) based food processing device of claim 1, further comprising the internet of things (IoT) based hand blender device configured to process the one or more contents in the one or more containers, wherein the internet of things (IoT) based hand blender device comprises:
one or more controller printed circuit boards (PCB) comprising a second microcontroller, wherein the second microcontroller is configured to:
receive the one or more inputs from at least one of: the one or more second user interfaces and one or more snap action switches, of the internet of things (IoT) based hand blender device, and the one or more applications configured in the one or more user devices; and
control at least one third variable speed 12-volt direct current (DC) motor to process the one or more contents based on the one or more inputs received from at least one of: the one or more second user interfaces and the one or more snap action switches, of the internet of things (IoT) based hand blender device, and the one or more applications configured in the one or more user devices.

7. The portable Internet of Things (IoT) based food processing device of claim 6, further comprising a kitchen scales attachment electrically connected to the internet of things (IoT) based hand blender device for weighing the one or more contents placed on a weighing tray using one or more weighing sensors attached with the weighing tray,
wherein the kitchen scales attachment is freely moved, using an electrical wire, to accommodate one or more sizes of the one or more containers for weighing the one or more containers, and
wherein the one or more weighing sensors are configured to provide one or more electrical data associated with the weightage of the one or more contents, to the internet of things (IoT) based hand blender device to compute one or more nutritional values in the one or more contents, and
wherein the kitchen scales attachment in connection with the internet of things (IoT) based hand blender device, is configured to at least one of: create one or more recipes and follow a guided cooking.

8. The portable Internet of Things (IoT) based food processing device of claim 7, wherein the second microcontroller is configured to:
obtain the one or more electrical data associated with the weightage of the one or more contents;
compare the one or more electrical data associated with the weightage of the one or more contents, with one or more pre-determined data associated with the one or more nutritional values in the one or more contents; and
compute the nutrition in the one or more contents based on the comparison of the one or more electrical data associated with the weightage of the one or more contents, with the one or more pre-determined data associated with the one or more nutritional values in the one or more contents.

9. The portable Internet of Things (IoT) based food processing device of claim 6, wherein the internet of things (IoT) based hand blender device further comprises one or more second camera devices configured to capture the one or more contents to determine one or more types of the one or more contents using the image recognition technique, and
wherein the second microcontroller utilizing the one or more second camera devices in connection with the kitchen scales attachment, is configured to detect one or more content type using the image recognition technique and to estimate the one or more nutritional values based on the one or more electrical data associated with the weightage.

10. The portable Internet of Things (IoT) based food processing device of claim 6, wherein the at least one third variable speed 12-volt direct current (DC) motor is mechanically connected to one or more second reduction gears to drive a food processor attachment with a food processor container, and
wherein the food processor attachment is fitted with the one or more weighing sensors to weigh the one or more contents in the food processor container and to send the one or more electrical data associated with the weightage to the second microcontroller for at least one of:
nutrition estimation and the recipe creation.

11. The portable Internet of Things (IoT) based food processing device of claim 6, wherein the at least one third variable speed 12-volt direct current (DC) motor is mechanically connected with a shaft fitted with a second coupler, which protrudes out of a housing of the internet of things (IoT) based hand blender device, wherein the shaft is mechanically attached to one or more third reduction gears to drive a beater attachment.

12. The portable Internet of Things (IoT) based food processing device of claim 6, wherein the internet of things (IoT) based hand blender device further comprises one or more pogo pins mechanically connected to the kitchen scales attachment through one or more pogo pin connectors, to weigh the one or more contents and to communicate the weightage of the one or more contents to the one or more second user interfaces through the second microcontroller.

13. The portable Internet of Things (IoT) based food processing device of claim 6, wherein the internet of things (IoT) based hand blender device further comprises one or more locking buttons that are configured to connect to at least one of: one or more content processing tools and the kitchen scales attachment,
wherein the one or more locking buttons connected to the one or more content processing tools are configured to control the one or more content processing tools when the one or more content processing tools are required to process.

14. The portable Internet of Things (IoT) based food processing device of claim 6, wherein cooking and prepping of the one or more contents in the one or more containers comprise at least one of: mixing, blending, chopping, grinding, crushing, whisking, frothing, kneading, of the one or more contents in the one or more containers.

15. The portable Internet of Things (IoT) based food processing device of claim 1, further comprising a companion apparatus connected with the automatic stirring apparatus for preparing the one or more contents in the one or more containers,
wherein the companion apparatus comprises:
an induction cooktop device with a thermometer for measuring surface temperature;
one or more legs connected with one or more load sensors for weighing the one or more contents in the one or more containers;
a mounting arm configured for holding the automatic stirring apparatus;
a hinge for combining the mounting arm and the induction cooktop device; and
a lid arranged on top of the one or more containers, wherein the lid is mechanically attached to the mounting arm, and
wherein the automatic stirring apparatus connected to the induction cooktop device, is configured to collect at least one of: the one or more inputs from the one or more users, the one or more sensor data, the one or more images to compute cooking time, cooking temperature, stirring speed, and the direction of the rotation of the at least one first variable speed 12-volt direct current (DC) motor.

16. An Internet of Things (IoT) based food processing method for automated cooking and prepping of one or more contents in one or more containers using a portable Internet of Things (IoT) based food processing device, the Internet of Things (IoT) based food processing method comprising:
connecting a stirring paddler device to a stirring shaft through a first coupler for adapting the stirring paddler device to stir the one or more contents in the one or more containers;
connecting an automatic stirring apparatus to at least two clamping arms to adapt for a slider motion of the automatic stirring apparatus, wherein the automatic stirring apparatus is configured to be mounted on a top of the one or more containers by utilizing the at least two clamping arms with at least two clamps and by placing the automatic stirring apparatus over a stirrer assembly,
wherein the at least two clamping arms comprise the at least two clamps configured to hold the one or more containers, and wherein the at least two clamping arms with the at least two clamps are configured to be adjusted based on size of the one or more containers;
receiving, by a first microcontroller, one or more inputs from at least one of: one or more first user interfaces and one or more touch buttons, of the automatic stirring apparatus, one or more second user interfaces and one or more touch screens, of an internet of things (IoT) based hand blender device, and one or more applications configured in one or more user devices;
receiving, by the first microcontroller, at least one of: one or more images from one or more first camera devices and one or more sensor data from one or more sensors configured in the automatic stirring apparatus, wherein the one or more sensor data received from the one or more sensors comprise at least one of: one or more temperature data and one or more smoke data, associated with the one or more containers during cooking and prepping of the one or more contents and wherein the one or more images received from the one or more first camera devices are processed with image recognition technique to determine a type of the one or more contents present in the one or more containers;
transmitting, by the first microcontroller, one or more signals to run at least one first variable speed 12-volt direct current (DC) motor to compute a load of the one or more contents in the one or more containers;
matching, by the first microcontroller, the one or more sensor data and the determined type of the one or more contents, with the computed load of the one or more contents to control speed and direction of rotation of the at least one first variable 12-volt speed direct current (DC) motor in at least one of: clockwise and counterclockwise direction, for stirring the one or more contents in the one or more containers using the stirring paddler device; and
connecting a range hood device to the automatic stirring apparatus using one or more pogo pins, wherein the range hood device comprises a circulation fan mechanically connected to at least one second variable speed 12-volt direct current (DC) motor, wherein the range hood device is controlled by the first microcontroller for at least one of: circulating heat, removing moisture, and filtering smoke, from the one or more containers during cooking process using the circulation fan, and
wherein the at least one second variable speed 12-volt direct current (DC) motor is configured to control speed of the circulation fan to vent the smoke and to provide one or more alerts to the one or more users, when a level of at least one of: temperature and the smoke, of the one or more containers exceeds one or more pre-determined threshold values.

17. The Internet of Things (IoT) based food processing method of claim 16, further comprising:
capturing, by the one or more first camera devices, the one or more images associated with the one or more contents in the one or more containers using the image recognition technique;
transmitting, by the one or more first camera devices, the one or more images associated with the one or more contents, to the first microcontroller;
automatically setting, by a first microcontroller, a cooking timer for a corresponding content in the one or more containers, based on the one or more images received from the one or more first camera devices; and
automatically managing, by the first microcontroller, the control speed and direction of the rotation of the at least one first variable speed 12-volt direct current (DC) motor for stirring the one or more contents in the one or more containers using a stirring paddler device, based on the one or more images captured by the one or more first camera devices and the one or more sensor data received from the one or more sensors.

18. The Internet of Things (IoT) based food processing method of claim 16, further comprising:
spraying, by an atomiser transducer device, one or more type of liquids in the one or more containers to dissipate heat when at least one of: burning, scorching, and sudden rise in one or more containers surface temperature, Wherein the atomiser transducer device is configured for spraying liquid seasonings, onto the contents in the one or more containers at a pre-defined time interval.

19. The Internet of Things (IoT) based food processing method of claim 16, further comprising processing, by the internet of things (IoT) based hand blender device, the one or more contents in the one or more containers, by:
receiving, by a second microcontroller, the one or more inputs from at least one of: the one or more second user interfaces and one or more snap action switches, of the internet of things (IoT) based hand blender device, and the one or more applications configured in the one or more user devices; and
controlling, by the second microcontroller, at least one third variable speed 12-volt direct current (DC) motor to process the one or more contents based on the one or more inputs received from at least one of: the one or more second user interfaces and the one or more snap action switches, of the internet of things (IoT) based hand blender device, and the one or more applications configured in the one or more user devices.

20. A non-transitory computer-readable storage medium having instructions stored therein that when executed by one or more hardware processors, cause the one or more hardware processors to execute operations of:
connecting a stirring paddler device to a stirring shaft through a first coupler for adapting the stirring paddler device to stir the one or more contents in the one or more containers;
connecting the automatic stirring apparatus to at least two clamping arms to adapt for a slider motion of the automatic stirring apparatus, wherein the automatic stirring apparatus is configured to be mounted on a top of the one or more containers by utilizing the at least two clamping arms with at least two clamps and by placing the automatic stirring apparatus over a stirrer assembly,
wherein the at least two clamping arms comprise the at least two clamps configured to hold the one or more containers and wherein the at least two clamping arms with the at least two clamps are configured to be adjusted based on size of the one or more containers;
receiving one or more inputs from at least one of: one or more first user interfaces and one or more touch buttons, of the automatic stirring apparatus, one or more second user interfaces and one or more touch screens, of an internet of things (IoT) based hand blender device, and one or more applications configured in one or more user devices;
receiving at least one of: one or more images from one or more first camera devices and one or more sensor data from one or more sensors configured in the automatic stirring apparatus, wherein the one or more sensor data received from the one or more sensors comprise at least one of: one or more temperature data and one or more smoke data, associated with the one or more containers during cooking and prepping of the one or more contents and wherein the one or more images received from the one or more first camera devices are processed with image recognition technique to determine a type of the one or more contents present in the one or more containers;
transmitting one or more signals to run at least one first variable speed 12-volt direct current (DC) motor to compute a load of the one or more contents in the one or more containers;
matching the one or more sensor data and the determined type of the one or more contents, with the computed load of the one or more contents to control speed and direction of rotation of the at least one first variable speed direct current (DC) motor in at least one of: clockwise and counter clockwise direction, for stirring the one or more contents in the one or more containers using the stirring paddler device; and
connecting a range hood device to the automatic stirring apparatus using one or more pogo pins, wherein the range hood device comprises a circulation fan mechanically connected to at least one second variable speed 12-volt direct current (DC) motor, wherein the range hood device is controlled by the first microcontroller for at least one of: circulating heat, removing moisture, and filtering smoke, from the one or more containers during cooking process using the circulation fan, and
wherein the at least one second variable speed 12-volt direct current (DC) motor is configured to control speed of the circulation fan to vent the smoke and to provide one or more alerts to the one or more users, when a level of at least one of: temperature and the smoke, of the one or more containers exceeds one or more pre-determined threshold values.
